(19) United States
(12) Patent Application Publication
(10) Pub. No.: US 2010/0286839 A1
(43) Pub. Date: Nov. 11, 2010

(54) APPARATUS FOR AUTOMATION OF THE OPERATIVE FUNCTIONALIITIES OF ONE OR MORE LOADS OF AN ENVIRONMENT

(75) Inventors: Armando Iaquinangelo, Cornaredo (IT); Alessandro Macchioni, Milano (IT)

Correspondence Address: CONNOLLY BOVE LODGE & HUTZ LLP, 1875 EYE STREET, N.W., SUITE 1100, WASHINGTON, DC, 20006, US

(73) Assignee: Consulting Engineering S.r.l., Novate Milanese (IT)

(21) Appl. No.: 12/668,234

(22) PCT Filed: Jul. 8, 2008
(86) PCT No.: PCT/EP08/58871

§ 371 Date: Apr. 30, 2010

(30) Foreign Application Priority Data
Jul. 10, 2007 (IT) TV2007A000123

(51) Int. Cl. G06F 1/26

(52) U.S. Cl. 700/295

(57) ABSTRACT

An apparatus for automation of the operative functionalities of one or more electrical loads of an environment, which comprises at least a centralized control device, comprising at least one processing unit, one or more peripheral electronic devices, operatively connected to said control device, and a digital communication network for enabling exchange of information between said control device and said peripheral electronic devices. Said control device comprises a software architecture of a distributed type, which comprises a plurality of software modules that mutually interact, so as to render substantially independent of one another the operations of configuration of the functionalities of said peripheral electronic devices and the operations of management of the flow of information from/to said peripheral electronic devices.

The present invention relates to the field of automation of environments pertaining to dwelling or working premises in buildings. In particular, the present invention relates to an apparatus for the automation of the operative functionalities of one or more electrical loads of an environment of interest.

It is known how, in the last few years, domestic automation (known also by the terms of “domotics” or “home automation”) and, more in general, automation of dwelling or working spaces of buildings (also known as “building automation”) has received a considerable impulse.

The technological solutions developed in the framework of said discipline enable, in fact, a co-ordinated, integrated and computerized management of the main systems or user devices of a building, a dwelling or, more in general, of any environment, markedly improving operative management thereof, for example, in terms of energy saving, comfort and/or quality of living and working conditions.

Currently, the market offers a large availability of technological solutions for automation of an environment.

Certain automation systems of a known type can be readily purchased at commercial centres or specialized shops and can be directly installed by the user. Unfortunately, the operative capacities of said automation systems generally present an extremely low flexibility and cannot be expanded or modified according to the user's requirements.

Other automation systems, such as the one described in the international patent application No. WO 03/40839, are characterized by a certain structural and functional flexibility. Said automation systems are, however, as a whole relatively costly and difficult to configure and program.

The state of the art offers also somewhat advanced technological solutions, capable of offering high levels of performance in terms of system automation. Said automation systems present, however, certain drawbacks, such as, for example, the use of a plurality of control units or the use of computer solutions and/or communication protocols that are strictly proprietary and hence difficult to interface with computer-program products commonly available on the market. This results in relatively high costs for the user, as regards the operative installation and management of the automation system.

It should moreover be noted how the automation systems of the known art are, in general, characterized by relatively high levels of energy consumption for supplying the control unit and/or the electronic boards installed.

Finally, very frequently automation systems of a known type require execution, for their installation, of specific masonry work or wiring, often with considerable drawbacks in functional and aesthetic terms.

Consequently, the primary aim of the present invention is to provide an apparatus for automation of the operative functionalities of one or more electrical loads of an environment that will enable the drawbacks indicated just above to be overcome.

In the framework of this aim, an object of the present invention is to provide an automation apparatus that affords levels of operative performance that are highly reliable, flexible, and readily adaptable to the user's requirements.

Another object of the present invention is to provide an automation apparatus that is easy to provide at an industrial level and is relatively inexpensive for the user, in particular as regards its installation and subsequent operative management.

A further object of the present invention is to provide an automation apparatus that presents relatively low levels of energy consumption and that can be installed with a relatively low functional and aesthetic negative impact.

The above aim and objects, as well as other purposes that will emerge clearly from the ensuing description and from the attached plates of drawings, are provided, according to the invention, by an apparatus for automation of the operative functionalities of one or more electrical loads of an environment, according to what is indicated in the following claim 1.

The automation apparatus, according to the present invention, comprises a centralized control device, which enables a convenient and co-ordinated management of the electrical loads controlled by the automation apparatus.

The automation apparatus according to the present invention likewise presents a modular structure, which can be readily expanded at a hardware/software level, is able to offer levels of performance that are very high and reliable, and are readily adaptable to the requirements of the user and of the environment of interest.

On account of its practical implementation, the automation apparatus according to the present invention does not require the use of hardware or software proprietary technologies, it being easily interfaceable with any type of electrical, electronic, or electromechanical device.

It is precisely on account of its marked structural simplicity, modularity, flexibility, and operative interfaceability that the automation apparatus according to the present invention presents relatively reduced costs of installation and operative management.

The automation apparatus according to the present invention comprises a communication network, which can be readily integrated with a secondary electrical-supply network and/or with the primary network for distribution of the electrical energy in the environment of interest. It can hence be set in operation by means of non-invasive interventions, with considerable functional and aesthetic benefits.

Further characteristics and advantages of the present invention may be appreciated more fully with reference to the description provided in what follows and to the attached plates of drawings, which are provided purely by way of illustrative and non-limiting example, and in which:

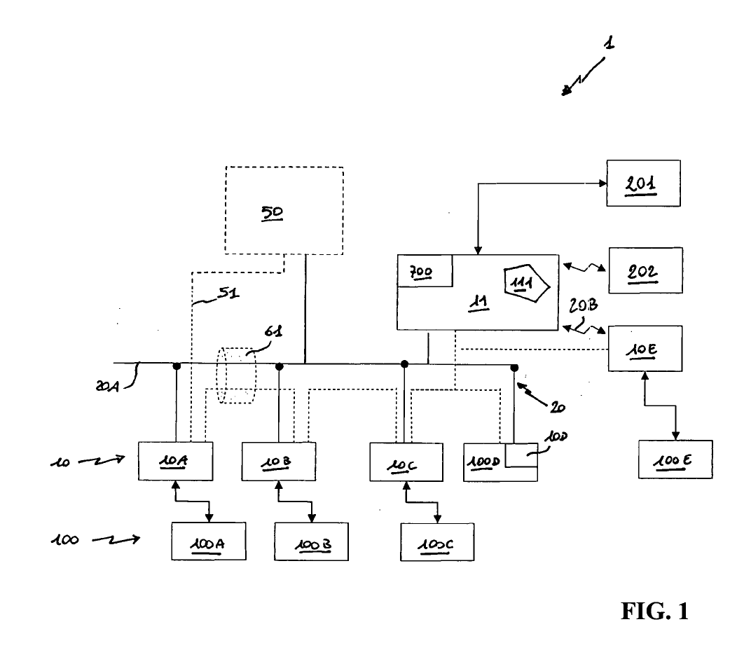

FIG. 1 is a schematic illustration of an embodiment of the automation apparatus according to the present invention;

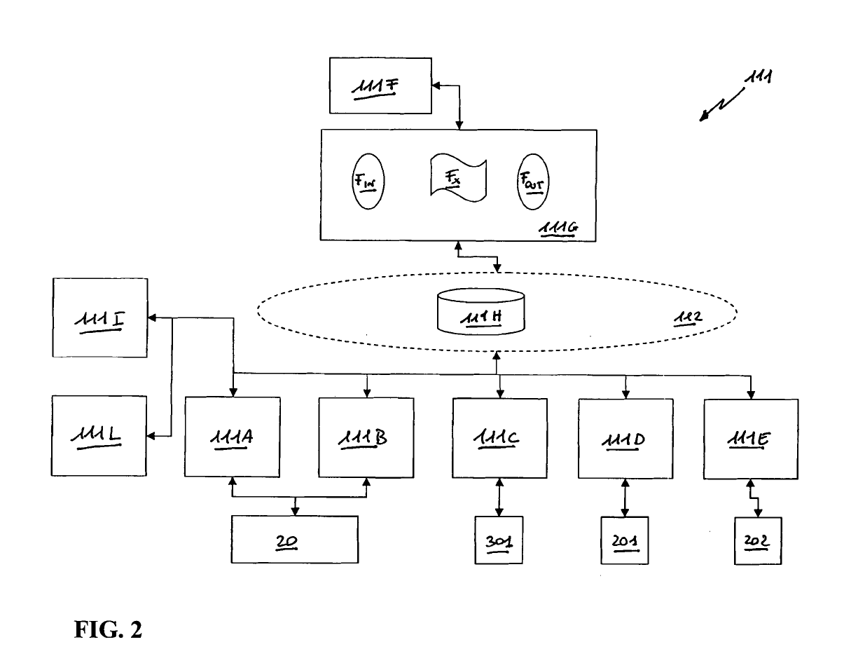

FIG. 2 is a schematic illustration of an embodiment of a software architecture, used in the automation apparatus according to the present invention;

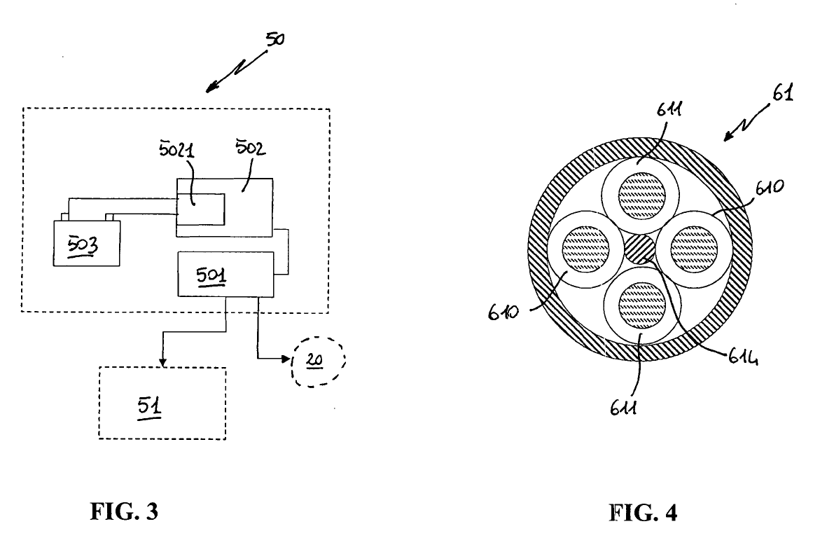

FIG. 3 is a schematic illustration of an embodiment of a source of electrical energy, used in the automation apparatus according to the present invention; and

FIG. 4 is a schematic illustration of an embodiment of a connection cable, used in the automation apparatus according to the present invention.

With reference to the aforesaid figures, the present invention relates to an apparatus 1 for automation of the operative functionalities of one or more electrical loads 100A-100E (designated as a whole by the reference number 100) of an environment, such as, for example, any dwelling, building, and/or area of interest.

The electrical loads 100 can comprise any type of electrical, electronic, and/or electromechanical device 1 of interest for the user. For example, without any intention to limit the scope of the present invention, the electrical loads 100 can refer to an air-conditioning system, a heating system, any household user device, a safety system, an audio-visual diffusion system, a system for moving devices for closing doors and windows and the like, a system for control of electrical household appliances, electronic regulation devices, sensor devices, actuator devices, and so forth.

The automation apparatus 1 comprises a centralized control device 11, provided with at least one processing unit (not illustrated), comprising, for example, one or more microprocessors. The automation apparatus 1 also comprises one or more peripheral electronic devices 10A-10E (designated as a whole by the reference number 10), operatively connected to the control device 11.

The peripheral devices 10 are advantageously used as interface between the control device 11 and the electrical loads 100. Purely by way of example, the peripheral devices 10 may comprise electronic devices, in turn comprising pre-defined sensor means and/or input communication channels, electronic devices for driving the electrical loads 100, electronic devices for programming the operative functions of the electrical loads 100, electronic-adapter devices for supplying electrical energy to the electrical loads 100, and so forth.

The peripheral devices 10 can be provided as autonomous units, operatively connected to the respective electrical loads 100 or else be integrated on board the latter (as in the case of the device 10D of FIG. 1).

The automation apparatus 1 also comprises a digital communication network 20 for enabling exchange of information between the control device 11 and the peripheral devices 10.

The digital communication network 20 preferably comprises a field bus 20A, for example a bus of a CAN (Control Area Network) type. This solution enables good levels of performance in terms of data traffic capacity to be combined with a considerable functional flexibility, immunity to disturbance, and reliability. For example, thanks to the use of a bus of a CAN type it is possible to avoid structured wiring (as will be seen more clearly hereinafter) and, at the same time, serve peripheral electronic devices with a relatively high number of input channels, with relatively high transmission rates, and at considerable distances.

The field bus 20A preferably implements a connection of the master-slave type between the control device 11 and peripheral devices 10A-10D. For managing the field bus 20A a “polling” method that envisages cyclic querying of the peripheral devices 10A-10D is preferably used. In the case where it were to become necessary to send emergency warning signals, it is also possible to use an “event” transmission mode so as to prevent useless wait times, particularly in the case where numerous peripheral devices 10 are present.

For a wireless connection of one or more peripheral devices (reference 10E), the digital communication network 20 can comprise also one or more wireless communication channels 20B, which use, for example, a ZIGBEE communication protocol or another equivalent protocol commonly used for management of WPANs (Wireless Personal Area Networks).

The use of the ZIGBEE protocol enables relatively high levels of performance to be achieved at relatively contained costs.

Also the communication channels 20B provide a master-slave connection between the control device 11 and the peripheral device 10E.

An interconnection module (not illustrated) can be used for interfacing further the aforesaid wireless communication network 20B with an infrared remote-control device, provided with a self-acquisition system (not illustrated). This could enable control, by means of a single remote-control device, of all the electrical household appliances that envisage a traditional remote control.

The control device 11 can be operatively connected, for example, by means of a further communication bus of a known type, with local-communication networks, for example with a LAN (Local Area Network) 201.

The control device 11 can also be operatively connected to a remote communication network 202, for example by means of a communication device of a GSM (Global System for Mobile communications) type.

The control device 11 advantageously comprises at least one user interface 700, which can consist of a classic monitor of the “touch-screen” type or even a television set. The navigation can advantageously occur through a series of graphic menus that are easily and immediately understandable, possibly selectable using a radio-mouse.

The control device 11 is provided with a software architecture 111 of a distributed type, comprising a plurality of software modules 111A-111L, interacting with one another (FIG. 2).

A first software module 111F is designed to generate a set of data indicating the structure, configuration and functionality of the electrical loads 100. The software module 111F uses data and information sent at input to the control device 11 by the installer or by the user, from the peripheral devices 10 themselves and/or from other devices/systems connected to the control unit 11. The first module 111F could also use information coming from an inferential motor (not illustrated), which uses a database for determining modes of operation of an adaptive type for the automation apparatus 1. Finally, the first software module 111F could also use information coming from a dedicated self-diagnosis system (not illustrated), advantageously capable of identifying and signalling a failure, in particular on board the peripheral devices 10.

The first software module 111F advantageously comprises at least one program for generating a representation of the environment in which the automation apparatus 1 is installed. In this way, the control device 11 can acquire a set of data regarding, for example, the topology of the aforesaid environment, the nature of the systems present, the functions that must be performed by each system, the data/commands to be supplied at input to each system, and other specific requirements of the user.

The first software module 111F moreover lists, for each portion of the environment of interest (for example, for each room in a dwelling), the functionalities that are to be implemented (for example, lights, heating, and alarms).

On the basis of the configuration processed for each portion of environment, the first software module 111F creates a list of the activities that are to be performed by the centralized control device 11 to ensure that the present systems will behave as desired.

In order to perform said activities, the software architecture 111 comprises a second software module 111G, designed to carry out a configuration of the functions to be performed by the peripheral electronic devices 10.

Said software module 111G advantageously comprises a program that executes a procedure articulated as described in what follows.

In a first step, the software module 111G acquires, on the basis of the information generated by the first software module 111F, one or more input variables F_{IN} necessary for execution of at least one software function F_{X} that describes a certain functionality to be performed. Said input variables may be entered by the user and/or come from the peripheral devices 10, from the aforesaid inferential motor, and/or from external devices/systems.

The software module 111G then proceeds to invoking the software function Fx so as to generate one or more output variables F_{OUT}. The output variables F_{OUT} are then used for generation of communication signals to be sent at input to the peripheral electronic devices 10 for execution of the aforesaid functionalities.

The software functions F_{X}, invoked by the software module 111G, are advantageously pre-defined according to the structure of the environment of interest and the user requirements. For example the software functions F_{X} can be programmed and stored in the database 111H, in the step of installation of the automation system 1 or subsequently, according to the contingent requirements. The software functions F_{X} could even be generated automatically on the basis of information coming from the inferential motor described above. Prior to their storage in the database 111H, the software functions F_{X} can be tested apart, in a dedicated simulation environment so as to be able to verify the effectiveness thereof.

The software functions F_{X} are advantageously supplied in a modular way, as combination of pre-defined programming code blocks. They are advantageously programmed so as to be able to supply different output variables F_{OUT} as a function of the variables F_{IN} received at input. In other words, they can be programmed for describing different functionalities, on the basis of the parameters F_{IN} received at input. The modularity (at the level of programming code) of the software functions F_{X}, even though it is more complex to implement practically, presents the undoubted advantage of rendering the functionalities of the peripheral electronic devices 10, and in practice the behaviour of the electrical loads 100, readily adaptable to the user requirements and to the different operative scenarios of the automation apparatus 1, without any need for additional software and/or hardware.

The software architecture 111 also comprises third software modules 111A-B for interfacing the centralized control device 11 with the digital communication network 20, hence both with the field bus 20A and with the wireless communication channels 20B.

The software modules 111A-B have the purpose of creating a logic relation between the output variables F_{OUT}, generated by the software module 111G, and the logic variables (not illustrated), regarding the input signals to be sent to the peripheral electronic devices 10, connected (in wired or wireless mode) to the communication network 20. In this way, corresponding to one or more output variables F_{OUT} generated is an input signal sent to the electronic device 10 designed for execution of the functionalities described by the aforesaid software function.

The software modules 111A-B advantageously use a back-up database 111H, where a plurality of addresses identifying the peripheral electronic devices 10 are stored.

Each of said identifier addresses is obtained through the logic composition of a plurality of field variables. Said composition is carried out in a step of initialization of the automation apparatus 1 (or downstream of a maintenance intervention), by a scanning of the communication network 20 and the corresponding verification of the presence of each of the peripheral electronic devices 10 envisaged.

The use of identifier addresses made up of a plurality of fields enables co-existence in one and the same communication network 20 of a plurality of peripheral electronic devices 10 of the same type but with functionalities that differ from one another.

It may be noted how said approach makes it possible to avoid a process of preventive initialization of the addresses of the peripheral devices 10, generally used in automation systems according to the state of the art. In addition, the use of multi-field addresses enables phenomena of collision in the communication network 20 to be avoided, for example, in the case where peripheral electronic devices of one and the same type but with differentiated functionalities are active.

From the above description, it is evident how the software architecture 111 comprises software modules (the modules 111G and 111A-B) that interact so as to render independent of one another the operations of configuration of the functionalities of the peripheral electronic devices 10 (entrusted to the module 111G) and the operations of management of the flow of information from/to said peripheral electronic devices 10 (entrusted to the modules 111A-B). In other words, the software architecture 111 envisages the existence of a level of abstraction 112 between the functionalities that must be performed by the peripheral electronic devices 10 and the hardware configuration of said peripheral devices. Said level of abstraction is physically implemented, in the embodiment of FIG. 2, by the database 111H but could find physical implementations that are more articulated as compared to the one illustrated.

For the activation (or configuration) of the functionalities to be executed, the centralized control device 11 does not interact directly with the peripheral devices 10, but uses a pre-defined description, or rather projection, of the hardware of said peripheral devices 10 in the software architecture 111. The interaction with the peripheral electronic devices 10 is consequently limited to the mere exchange of input/output signals, with considerable benefits in terms of operative flexibility.

In a preferred embodiment, the software architecture 111 comprises at least one fourth software module 111C for managing interfacing of the control device 11 with one or more external control apparatuses 301, for example, with automation apparatuses of a traditional type.

Preferably, moreover, the software architecture 111 comprises at least one fifth software module 111D for interfacing the control device 11 with one or more local-communication networks 201. A corresponding sixth software module 111E can be pre-arranged for interfacing with wireless communication networks 202.

In a preferred embodiment, the software architecture 111 could comprise at least one seventh software module 111I for implementing user-interface functionalities (reference 700 of FIG. 1). As has been mentioned above, said functionalities can comprise a series of scroll menus that are readily usable by the user. Obviously, it is possible to use user-interface functionalities of a more traditional type.

Finally, the software architecture 111 could comprise also an eighth software module 111L designed to implement “data-logger” functionalities, using, for example, the database 111H for storing significant events/data (for example, safety alarms) detected during operation of the automation apparatus 1.

In a preferred embodiment, the automation apparatus 1 comprises a source of electrical energy 50 for supplying electrical energy to a secondary supply network 51 designed to transmit electrical energy to the peripheral electronic devices 10 and/or to the control device 11.

For supply of the electronic components of the automation apparatus 1, the secondary network 51 operates, obviously, at a much lower voltage as compared to the voltage of the primary network (not illustrated) for distribution of the electrical energy. In fact, the secondary network 51 is advantageously pre-arranged for transmitting electrical energy with a 24-Vdc voltage. Said operating voltage makes it possible to limit the section of the supply cables, consequently limiting the voltage drop along the supply line. This evidently enables a reduction in the overall energy consumption of the automation apparatus 1.

Advantageously, the secondary network 51 can be used, where necessary, for direct supply also of an electrical load 100D. Said solution presents the advantage of avoiding use of transformation units on board the electrical loads 100. This fact entails, in addition to a decrease in the total costs of the plants used, also an overall increase in the level of safety and reliability of the electrical loads 100.

Preferably, the source of electrical energy 50 comprises a main supply electronic device 501 (FIG. 3), operatively connected to the secondary network 51 and to the digital communication network 20.

The electronic device 501 is preferably connected to a secondary supply electronic device 502, pre-arranged for supplying the secondary distribution network 51, in the case of interruption of service by the electronic device 501.

The electronic device 502 is, in turn, operatively connected to a stand-by battery 503, which is designed to intervene in the case of interruption of service of both of the electronic devices 502 and 503. Preferably, the device 502 comprises electronic means 5021 designed to maintain the stand-by battery 503 constantly charged.

It is evident how the energy source 50 is able to ensure a considerable reliability of service, together with a relatively high efficiency. The connection to the digital communication network 20 enables the energy source 50 to carry out diagnostic cycles of its own state, communicating the results thereof to the control device 11. On the other hand, the control device 11 can in turn manage activation of each of the component devices that constitute the energy source 50, as if it were any peripheral electronic device controlled by the automation apparatus 1.

In a further preferred embodiment, the automation apparatus 1 comprises wiring means 61 for (physically) integrating the secondary network 51 and the digital communication network 20 with one another.

The aforesaid wiring means comprise a connection cable 61, which in turn comprises an outer cladding 612 and a filler 614 made of insulating material. The cable 61 comprises one or more conductors 610 designed to transmit electrical energy, and one or more conductors 611 designed to transmit digital-communication signals. In this way, it enables simultaneous transmission of electrical energy and information. As illustrated in FIG. 4, a pair of conductors 610 set at the voltage of 0Vdc and 24Vdc enables transmission of d.c. electrical energy. A pair of conductors 611 enables provision of a transmission bus of a CAN type, particularly suitable for this type of solution, given that it presents a high immunity to electromagnetic disturbance.

The cable 61 advantageously has relatively reduced dimensions, comparable to a television-antenna cable, and a considerable structural flexibility. In this way, it can be readily inserted inside the corrugated tubes and the junction boxes, commonly used in the primary network for distribution of the electrical energy.

There is consequently obtained a considerable reduction in the invasiveness of the automation apparatus 1 in regard to the environment of interest. Said reduction is progressively more marked if it is considered that many components of the automation apparatus 1 (such as, for example, the peripheral electronic devices 10) can be set in points corresponding to the aforesaid junction boxes, thus being perfectly integrated in the environment, without any need for additional works.

It has in practice been seen that the automation apparatus according to the present invention enables the pre-set task and purposes to be achieved.

The use of a centralized control makes it possible to avoid the use of multiple control units and, more in general, the superposed and concurrent use of dedicated hardware and software to meet the different requirements of the user, with the consequent reduction in the overall energy consumption of the automation apparatus 1.

The aforesaid centralized control enables on the other hand convenient management of any type of service for the living space of interest. For example, it is possible to manage in a co-ordinated way supply of electrical energy by means of a plurality of production systems concurrent with one another, such as, for example, photovoltaic panels, other systems for production of alternative electrical energy, and primary electrical network. Said co-ordination can be performed starting from the routine requirements of the user (for example, use of a washing machine, a dish washer, etc.), from his or her immediate needs (for example, requirement for hot water for a shower) and/or according to the type/cost of the energy source available. The control device 11, for example by means of the aforementioned inferential motor, can acquire information on the actual requirements of consumption of the user and/or on the efficiency/cost of the energy sources available and optimize the supply of electrical energy according to an extremely wide range of parameters of interest. It is evident how all this entails a considerable rationalization of levels of energy consumption (in particular, consumption from the primary electrical network) and optimization of the use of possible alternative/renewable energy sources.

On the other hand, the modular structure of the software architecture 111, both at the level of structuring of the modules and at the level of programming code, enables an extreme flexibility of use and adaptability to the environment in which the automation apparatus is to be installed. Said modular structure enables expansion of the operational capacities of the automation system 1, according to the requirements.

On account of its very construction, the automation apparatus according to the present invention does not call for proprietary technologies above all as regards the programming languages and the communication protocols. For the control device 11 itself a common computer can be used. This enables considerable benefits in terms of reduction of the costs of installation and of operational management to be achieved.

The automation apparatus according to the present invention is characterized by a high reliability of operation, with relatively reduced energy consumptions. The possible integration between the secondary supply network, the digital communication network and pre-existing primary network for distribution of the electrical energy enables ease of installation, without the need for invasive works with considerable benefits from the functional and aesthetic standpoint.

1. An apparatus for automation of the operative functionalities of one or more electrical loads of an environment, comprising at least:
a centralized control device, comprising at least one processing unit;
one or more peripheral electronic devices, operatively connected to said control device; and
a digital communication network for enabling exchange of information between said control device and said peripheral electronic devices;
characterized in that said control device comprises a software architecture of a distributed type, said software architecture being provided with a plurality of software modules, which mutually interact and render substantially independent of one another the operations of configuration of the functionalities of said peripheral electronic devices and the operations of management of the flow of information from/to said peripheral electronic devices.

2. The automation apparatus according to claim 1, characterized in that said peripheral electronic devices comprise:
one or more electronic interface devices comprising one or more communication input channels; and/or
one or more electronic interface devices comprising pre-defined sensor means; and/or
one or more electronic devices for driving said electrical loads; and/or
one or more electronic devices for programming the operative functions of said electrical loads; and/or
one of said electronic-adapter devices for supplying electrical energy to one or more of said electrical loads.

3. The automation apparatus according to claim 1,
characterized in that said digital communication network comprises at least one field bus and/or at least one digital-communication channel of a wireless type.

4. The automation apparatus according to claim 1,
characterized in that it comprises a source of electrical energy, designed to supply electrical energy, for voltage values lower than the voltage of the primary network for distribution of the electrical energy in said environment, to a secondary supply network, electrically connected to said peripheral electronic devices and/or to said control device, said secondary supply network being electrically connected to one or more of said electrical loads.

5. The automation apparatus according to claim 4, characterized in that said source of electrical energy comprises:
a main supply electronic device, operatively connected to said secondary supply network and to said digital communication network; and
a secondary supply electronic device, operatively connected to said main supply electronic device, said secondary supply electronic device comprising electronic means for electrical recharge of a stand-by battery; and
wiring means, for integrating physically with one another at least one portion of said secondary supply network and at least one portion of said digital communication network, said wiring means comprising at least one connection cable comprising at least one conductor designed to transmit electrical energy and at least one conductor designed to transmit digital-communication signals, said connection cable being inserted in at least one corrugated tube and/or in a junction box of the primary network for distribution of the electrical energy for said environment.

6. The automation apparatus according to claim 1, characterized in that said software architecture comprises a first software module designed to generate a set of data indicating the structure, configuration, and functionalities of said electrical loads in said environment.

7. The automation apparatus according to claim 1, characterized in that said software architecture comprises a second software module designed to carry out, on the basis of the information generated by said first software module, the configuration of the functionalities that must be performed by said peripheral electronic devices.

8. The automation apparatus according to claim 7, characterized in that said second software module executes a method that comprises the following steps:
acquiring one or more input variables (F_{IN}), for execution of at least one software ftrnction (F_{X}) that describes one of said functionalities to be executed;
invoking said software function; and
generating one or more output variables (F_{OUT}), to be used for generation of signals to be sent at input to said peripheral electronic devices.

9. The automation apparatus according to claim 1, characterized in that said software architecture comprises at least one third software module for interfacing said control device with said digital communication network.

10. The automation apparatus according to claim 1, characterized in that said software architecture comprises a back-up database, said back-up database comprising a plurality of addresses identifying said peripheral electronic devices, each of said identifier addresses being obtained through the logic composition of a plurality of field variables.

11. The automation apparatus according to claim 1, characterized in that said software architecture comprises at least one fourth software module for interfacing said control device with one or more external control apparatuses.

12. The automation apparatus according to claim 1, characterized in that said software architecture comprises at least one fifth software module for interfacing said control device with one or more local-communication networks.

13. The automation apparatus according to claim 1, characterized in that said software architecture comprises at least one sixth software module for interfacing said control device with one or more communication networks of a wireless type.

14. The automation apparatus according to claim 1, characterized in that said software architecture comprises at least one seventh software module for implementing user-interface functionalities.

15. The automation apparatus according to claim 1, characterized in that said software architecture comprises at least one seventh software module for implementing data-logger functionalities.

16. The automation apparatus according to claim 2,
characterized in that said digital communication network comprises at least one field bus and/or at least one digital-communication channel of a wireless type.

17. The automation apparatus according to claim 2,
characterized in that it comprises a source of electrical energy, designed to supply electrical energy, for voltage values lower than the voltage of the primary network for
distribution of the electrical energy in said environment, to a secondary supply network, electrically connected to said peripheral electronic devices and/or to said control device, said secondary supply network being electrically connected to one or more of said electrical loads.

18. The automation apparatus according to claim 3,
characterized in that it comprises a source of electrical energy, designed to supply electrical energy, for voltage values lower than the voltage of the primary network for
distribution of the electrical energy in said environment, to a secondary supply network, electrically connected to said peripheral electronic devices and/or to said control device, said secondary supply network being electrically connected to one or more of said electrical loads.

19. The automation apparatus according to claim 2, characterized in that said software architecture comprises a first software module designed to generate a set of data indicating the structure, configuration, and functionalities of said electrical loads in said environment.

20. The automation apparatus according to claim 3, characterized in that said software architecture comprises a first software module designed to generate a set of data indicating the structure, configuration, and functionalities of said electrical loads in said environment.
